(19) United States
(12) Patent Application Publication
(10) Pub. No.: US 2020/0159318 A1
(43) Pub. Date: May 21, 2020

(54) INFORMATION PROCESSING DEVICE, INFORMATION PROCESSING METHOD, AND COMPUTER PROGRAM

(71) Applicant: SONY CORPORATION, TOKYO (JP)

(72) Inventors: AKANE KONDO, TOKYO (JP); RYO FUKAZAWA, KANAGAWA (JP); KEI NITTA, TOKYO (JP)

(21) Appl. No.: 16/631,907

(22) PCT Filed: May 10, 2018
(86) PCT No.: PCT/JP2018/018108

§ 371 Date: Jan. 17, 2020

(30) Foreign Application Priority Data
Jul. 27, 2017 (JP) 2017-145590

(51) Int. Cl. G06F 3/01; G09G 5/38; G06T 7/90; G06T 11/00; G02B 27/01

(52) U.S. Cl. CPC G06F 3/013; G09G 5/38; G06T 7/90; G06T 11/00; G02B 2027/0181; G02B 27/0179; G02B 2027/0178; G02B 2027/014; G02B 27/0172

(57) ABSTRACT

[Problem] An information processing device, an information processing method, and a computer program are provided.

[Solution] The information processing device includes: a conspicuous region specification unit configured to specify a conspicuous region that can relatively easily attract visual attention of a user in a field of vision of the user; and a display control unit configured to perform display control to dispose a virtual object in the conspicuous region.

### FIELD

The present disclosure relates to an information processing device, an information processing method, and a computer program.

### BACKGROUND

In recent years, a technique of superimposing a virtual object on a real space to be presented to a user, which is called Augmented Reality (AR), has been attracting attention. For example, by using a projector or a Head Mounted Display (hereinafter, also referred to as an “HMD”) including a display that is positioned in front of the eyes of the user when being worn on a head part of the user, a virtual object is enabled to be displayed while being superimposed on a real space.

In such an AR technique, the virtual object may be disposed based on information of the real space, for example. For example, the following Patent Literature 1 discloses a technique of disposing a virtual object based on positional information of the real space or a real object present in the real space.

### CITATION LIST

### Patent Literature

Patent Literature 1: WO 2014/162823

### SUMMARY

### Technical Problem

However, in such a case in which the virtual object is disposed based on the information of the real space, the virtual object is not necessarily displayed at a desirable position for the user, and for example, the virtual object is displayed at a position that is hardly found by the user in some cases.

The present disclosure provides new and improved information processing device, information processing method, and computer program that enable a virtual object to be displayed at a position that can be easily found by a user.

### Solution to Problem

According to the present disclosure, an information processing device is provided that includes: a conspicuous region specification unit configured to specify a conspicuous region that is able to relatively easily attract visual attention of a user in a field of vision of the user; and a display control unit configured to perform display control to dispose a virtual object in the conspicuous region.

Moreover, according to the present disclosure, an information processing method is provided that includes: specifying a conspicuous region that is able to relatively easily attract visual attention of a user in a field of vision of the user; and performing display control to dispose a virtual object in the conspicuous region by a processor.

Moreover, according to the present disclosure, a computer program is provided that causes a computer to execute: a function of specifying a conspicuous region that is able to relatively easily attract visual attention of a user in a field of vision of the user; and a function of performing display control to dispose a virtual object in the conspicuous region.

### Advantageous Effects of Invention

As described above, according to the present disclosure, the virtual object can be displayed at a position that can be easily found by the user.

The effects described above are not limitations, and any of the effects disclosed herein or another effect that may be grasped from the present description may be exhibited in addition to the effects described above, or in place of the effects described above.

### BRIEF DESCRIPTION OF DRAWINGS

FIG. 1 is a diagram for explaining an outline of an information processing device 1 according to an embodiment of the present disclosure.

FIG. 2 is a block diagram illustrating a configuration example of the information processing device 1 according to the embodiment.

FIG. 3 is a flowchart illustrating an operation example of the information processing device 1 according to the embodiment.

FIG. 4 is a flowchart illustrating processing at Step S40 illustrated in FIG. 3 in more detail.

FIG. 5 is an explanatory diagram for explaining an example in which a virtual object is disposed in a conspicuous region along an edge in the vicinity of a gazing point.

FIG. 6 is an explanatory diagram for explaining another example in which the virtual object is disposed in the conspicuous region.

FIG. 7 is an explanatory diagram for explaining a first modification according to the embodiment.

FIG. 8 is an explanatory diagram for explaining a second modification according to the embodiment.

FIG. 9 is an explanatory diagram illustrating a hardware configuration example.

### DESCRIPTION OF EMBODIMENTS

The following describes a preferred embodiment of the present disclosure in detail with reference to the attached drawings. In the present description and the drawings, constituent elements having substantially the same functional configuration are denoted by the same reference numeral, and redundant description will not be repeated.

The description will be made in the following order.

1. Outline

2. Configuration

3. Operation

4. Specific example in which virtual object is disposed in conspicuous region
4-1. First specific example
4-2. Second specific example

5. Modification
5-1. First modification
5-2. Second modification
5-3. Third modification

6. Hardware configuration example

7. Conclusion

### 1. Outline

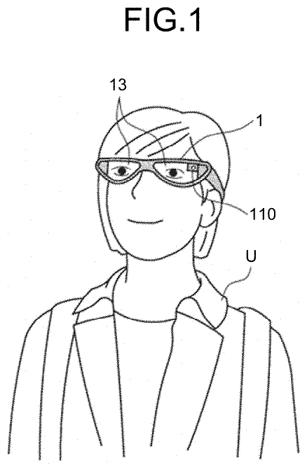

First, the following describes an outline of an information processing device according to an embodiment of the present disclosure. FIG. 1 is a diagram for explaining an outline of an information processing device 1 according to the embodiment. As illustrated in FIG. 1, the information processing device 1 according to the embodiment is implemented by a spectacle-type Head Mounted Display (HMD) worn on a head part of a user U, for example. Display units 13 corresponding to spectacle lens portions that are positioned in front of the eyes of the user U when being worn may be a transmissive type or a non-transmissive type. The information processing device 1 can present a virtual object in a field of vision of the user U by displaying the virtual object on the display units 13. The HMD as an example of the information processing device 1 is not limited to present an image to both eyes, and may present the image to only one eye. For example, the HMD may be a monocular type including the display unit 13 that presents an image to one eye disposed therein.

The information processing device 1 includes an outward camera 110 disposed therein that images a direction of line of sight of the user U, that is, the field of vision of the user when being worn. Additionally, although not illustrated in FIG. 1, the information processing device 1 also includes various sensors disposed therein such as an inward camera that images the eye of the user U when being worn and a microphone (hereinafter, referred to as a “mic”). A plurality of outward cameras 110 and inward cameras may be disposed.

The shape of the information processing device 1 is not limited to the example illustrated in FIG. 1. For example, the information processing device 1 may be a headband-type (a type of being worn with a band wound around the entire circumference of the head part. In some cases, there may be disposed a band passing through not only a temporal region but also a head top part) HMD, or a helmet-type (a visor portion of the helmet corresponds to the display) HMD. The information processing device 1 may also be implemented by a wearable device of a wristband type (for example, a smart watch including a display or no display), a headphone type (without a display), a neckphone type (a neck-hanging type including a display or no display), or the like.

For example, in a case in which the display unit 13 is a transmissive type, the information processing device 1 can perform display control to dispose a virtual object in a real space based on information of the real space (an example of the field of vision of the user) obtained through photographing performed by the outward camera 110.

In this case, the user U hardly find the virtual object in some cases depending on a position at which the virtual object is disposed. In a case in which the virtual object is a virtual object related to an operation input, it may be difficult to grasp a sense of distance to the virtual object for the user U depending on a position at which the virtual object is disposed, and an operation input may be hardly made or a misoperation may be caused.

Thus, the information processing device 1 according to the embodiment implements disposition of the virtual object so that the user can easily find the virtual object and grasp a sense of distance thereto. Specifically, the information processing device 1 according to the embodiment performs display control to dispose the virtual object in a conspicuous region that can relatively easily attract visual attention of the user within the field of vision of the user (part of the real space).

### 2. Configuration

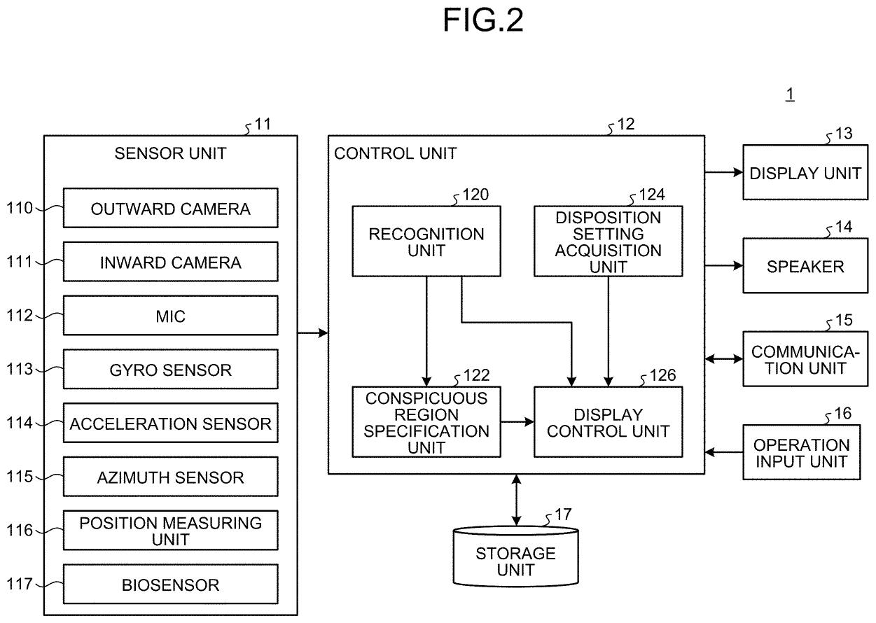

The outline of the information processing device 1 according to the embodiment has been described above. Subsequently, the following describes a configuration of the information processing device 1 according to the embodiment with reference to FIG. 2. FIG. 2 is a block diagram illustrating a configuration example of the information processing device 1 according to the embodiment. As illustrated in FIG. 2, the information processing device 1 includes a sensor unit 11, a control unit 12, a display unit 13, a speaker 14, a communication unit 15, an operation input unit 16, and a storage unit 17.

Sensor Unit 11

The sensor unit 11 has a function of acquiring various kinds of information about the user or a peripheral environment. For example, the sensor unit 11 includes the outward camera 110, an inward camera 111, a mic 112, a gyro sensor 113, an acceleration sensor 114, an azimuth sensor 115, a position measuring unit 116, and a biosensor 117. A specific example of the sensor unit 11 described herein is merely an example, and the embodiment is not limited thereto. Additionally, a plurality of sensors may be disposed.

Each of the outward camera 110 and the inward camera 111 includes a lens system constituted of an imaging lens, a diaphragm, a zoom lens, a focus lens, and the like, a driving system that causes the lens system to perform a focus operation or a zoom operation, a solid-state imaging element array that photoelectrically converts imaging light obtained by the lens system to generate an imaging signal, and the like. The solid-state imaging element array may be implemented by a Charge Coupled Device (CCD) sensor array, or a Complementary Metal Oxide Semiconductor (CMOS) sensor array, for example.

In the embodiment, it is desirable to set an angle of view and an orientation of the outward camera 110 so as to image a region corresponding to the field of vision of the user in the real space.

The mic 112 collects voice of the user and environmental sound of the surroundings to be output to the control unit 12 as voice data.

The gyro sensor 113 is implemented by a triaxial gyro sensor, for example, and detects an angular speed (rotational speed).

The acceleration sensor 114 is implemented by a triaxial acceleration sensor (also referred to as a G sensor), for example, and detects acceleration at the time of movement.

The azimuth sensor 115 is implemented by a triaxial geomagnetic sensor (compass), for example, and detects an absolute direction (azimuth).

The position measuring unit 116 has a function of detecting a present position of the information processing device 1 based on a signal acquired from the outside. Specifically, the position measuring unit 116 is implemented by a Global Positioning System (GPS) measuring unit, for example, receives radio waves from GPS satellites, detects a position at which the information processing device 1 is present, and outputs detected positional information to the control unit 12. Alternatively, the position measuring unit 116 may detect the position, for example, via Wi-Fi (registered trademark), Bluetooth (registered trademark), transmission/reception of data to/from a cellular telephone, a PHS, a smartphone, and the like, short-range communication, or the like in place of the GPS.

The biosensor 117 detects biological information of the user. Specifically, for example, the biosensor 117 may detect heartbeats, a body temperature, sweating, a blood pressure, a pulse, respiration, nictitation, an eye movement, a gazing time, a size of pupil diameter, a blood pressure, brain waves, body motion, a posture, a skin temperature, electric skin resistance, micro vibration (MV), a myoelectric potential, blood oxygen saturation (SPO2), or the like.

Control Unit 12

The control unit 12 functions as an arithmetic processing device and a control device, and controls the entire operation in the information processing device 1 in accordance with various computer programs. As illustrated in FIG. 2, the control unit 12 according to the embodiment functions as a recognition unit 120, a conspicuous region specification unit 122, a disposition setting acquisition unit 124, and a display control unit 126.

The recognition unit 120 has a function of recognizing (or detecting) the information about the user or the information about the peripheral situation by using various kinds of sensor information sensed by the sensor unit 11.

For example, the recognition unit 120 may recognize a position and a posture of the head part of the user (including an orientation or inclination of a face with respect to a body), a line of sight of the user, a gazing point of the user, and the like as the information about the user. The recognition unit 120 may detect the gazing point of the user based on the line of sight of the user. For example, in a case in which the line of sight of the user is retained in a certain range for a predetermined time or more, the recognition unit 120 may detect a point (three-dimensional position) ahead of the line of sight of the user as the gazing point. The method of detecting the gazing point of the user performed by the recognition unit 120 is not limited to the example described above, and various known methods may be used.

The recognition unit 120 may also recognize a three-dimensional shape in the field of vision of the user as the information about the peripheral situation. For example, in a case in which a plurality of outward cameras 110 are disposed, the recognition unit 120 may obtain a depth image (distance image) based on parallax information, and recognize a three-dimensional shape in the field of vision of the user. Even in a case in which only one outward camera 110 is disposed, the recognition unit 120 may recognize a three-dimensional shape in the field of vision of the user from images that are acquired on a time-series basis.

The recognition unit 120 may also detect a boundary surface of a real object from the field of vision of the user as the information about the peripheral situation. In the present description, an expression of the “boundary surface” is used as an expression including, for example, a surface between the real object and another real object, or a surface between the real object and a space in which the real object is not present. The boundary surface may be a curved surface.

The recognition unit 120 may detect the boundary surface from an image acquired by the outward camera 110, or may detect a boundary surface based on a recognized three-dimensional shape in the field of vision of the user. For example, in a case in which the three-dimensional shape in the field of vision of the user is expressed as point group data, the recognition unit 120 may detect the boundary surface by performing clustering on the point group data. The method of detecting the boundary surface performed by the recognition unit 120 is not limited to the example described above, and various known methods may be used.

The recognition unit 120 provides the recognized information about the user and information about the peripheral situation to the conspicuous region specification unit 122 and the display control unit 126.

The conspicuous region specification unit 122 specifies a conspicuous region that can relatively easily attract visual attention of the user in the field of vision of the user. In the present description, “that can easily attract visual attention” may be assumed to mean “that has a visual characteristic that can easily attract attention of people”. The conspicuous region specification unit 122 may specify the conspicuous region based on information recognized by the recognition unit 120, for example. The conspicuous region specified by the conspicuous region specification unit 122 is provided to the display control unit 126 (described later), and the display control unit 126 performs display control to dispose a virtual object in the conspicuous region.

The conspicuous region specification unit 122 may specify the conspicuous region on the boundary surface detected from the field of vision by the recognition unit 120, for example. The display control unit 126 (described later) performs display control to dispose the virtual object in the conspicuous region, so that the virtual object can be disposed on the boundary surface with the configuration described above. Thus, with this configuration, the user can easily grasp a sense of distance to the virtual object as compared with a case in which the virtual object is disposed in a space in which the real object is not present.

The conspicuous region specification unit 122 may specify the conspicuous region based on an edge of the boundary surface detected from the field of vision. The conspicuous region specification unit 122 may detect, as the edge, an end portion of the boundary surface detected by the recognition unit 120, for example. The edge detected by the conspicuous region specification unit 122 may have a linear shape or a curved shape. The conspicuous region specification unit 122 may detect the edge from the image acquired by the outward camera 110, or may detect the edge based on a three-dimensional shape of the boundary surface. The edge is obvious for the user, and the user does not easily lose sight of the edge, so that, when the conspicuous region is specified based on the edge, an effect is exhibited such that the user does not easily lose sight of the virtual object disposed in the conspicuous region.

For example, the conspicuous region specification unit 122 may specify a region along the edge as the conspicuous region, or may specify the conspicuous region based on a combination of the edge and another element described later.

The conspicuous region specification unit 122 may also specify the conspicuous region based on the gazing point of the user detected by the recognition unit 120. For example, in a case in which the gazing point of the user is detected on a certain boundary surface, the conspicuous region specification unit 122 may specify the conspicuous region on the boundary surface on which the gazing point is positioned. With this configuration, the virtual object can be disposed on the boundary surface gazed at by the user, and the user is enabled to easily find the virtual object as compared with a case in which the virtual object is disposed on a boundary surface that is not gazed at by the user.

In a case in which the gazing point of the user is detected on a certain boundary surface, the conspicuous region specification unit 122 may detect the edge of the boundary surface on which the gazing point is positioned. In a case in which the edge is detected in the vicinity of the gazing point, the conspicuous region specification unit 122 may specify, as the conspicuous region, a region on the boundary surface along the detected edge. In a case in which a plurality of edges are detected in the vicinity of the gazing point, the conspicuous region specification unit 122 may specify, as the conspicuous region, a region on the boundary surface along an edge closest to the gazing point. With this configuration, the virtual object can be disposed in a region that is close to the gazing point of the user and can relatively easily attract visual attention of the user, and the user is enabled to find the virtual object more easily.

The conspicuous region specification unit 122 does not necessarily specify the conspicuous region in a case in which the gazing point of the user is detected on a certain boundary surface but the edge is not detected in the vicinity of the gazing point.

In a case in which the gazing point is not detected, a case in which the detected gazing point is not positioned on any of boundary surfaces, or a case in which the boundary surface on which the gazing point is positioned is not a preferable boundary surface, the conspicuous region specification unit 122 may specify the conspicuous region by a method not using the gazing point as described below. The case in which the boundary surface is not a preferable boundary surface is, for example, a case in which it is difficult to dispose the virtual object in the conspicuous region even if the conspicuous region is specified on the boundary surface, and may be a case in which an area of the boundary surface is equal to or smaller than a predetermined threshold, for example.

For example, the conspicuous region specification unit 122 may specify the conspicuous region based on color information in the field of vision. The color information in the field of vision may be acquired from an image that is acquired by the outward camera 110, for example.

For example, the conspicuous region specification unit 122 may specify a conspicuous score indicating ease of attracting visual attention of the user based on the color information, and specify the conspicuous region based on the conspicuous score. The method of specifying the conspicuous score based on the color information is not limited, and for example, the conspicuous region specification unit 122 may specify the conspicuous score based on a color of background, a size of color, intensity of color, duration of color, movement of color, and the like. The conspicuous region specification unit 122 may also specify the conspicuous score so that the conspicuous score of a chromatic color is higher than that of an achromatic color. The conspicuous region specification unit 122 may also specify the conspicuous score so that the conspicuous score of a color close to white is higher than that of a color close to black. The conspicuous region specification unit 122 may also specify the conspicuous score so that the conspicuous score of a warm color is higher than that of a cold color. The conspicuous region specification unit 122 may also specify the conspicuous score so that the conspicuous score of a high saturation color is higher than that of a low saturation color.

The method of specifying the conspicuous score performed by the conspicuous region specification unit 122 is not limited to the specification method based on the color information. For example, the conspicuous region specification unit 122 may specify the conspicuous score based on the edge described above, or may specify the conspicuous score so that the conspicuous score of a region along the edge becomes high. The conspicuous score may also be specified by combining the specification method based on the color information described above and the specification method based on the edge.

For example, the conspicuous region specification unit 122 may specify the conspicuous score described above for each boundary surface detected by the recognition unit 120, and specify the conspicuous region on a boundary surface having the highest conspicuous score. With this configuration, the virtual object can be disposed on a boundary surface that can most easily attract visual attention of the user in the field of vision of the user, and the user is enabled to find the virtual object more easily.

The conspicuous region specification unit 122 may specify the conspicuous score for each position on the boundary surface having the highest conspicuous score, and specify the conspicuous region based on the conspicuous score that is specified for each position on the boundary surface. The method of specifying the conspicuous region based on the conspicuous score that is specified for each position on the boundary surface is not limited. Alternatively, the conspicuous region specification unit 122 may specify, as the conspicuous region, an overlapping region of the region along the edge and a predetermined range centered on a point having the highest conspicuous score based on the color information. For example, the conspicuous region specification unit 122 may specify, as the conspicuous region, an overlapping region of a region having the conspicuous score equal to or larger than a predetermined threshold and a predetermined range centered on a point having the highest conspicuous score.

The conspicuous region specification unit 122 does not necessarily specify the conspicuous region in a case in which the conspicuous score of the boundary surface having the highest conspicuous score is equal to or smaller than the predetermined threshold, or a case in which all conspicuous scores for the respective positions on the boundary surface are equal to or smaller than the predetermined threshold.

The disposition setting acquisition unit 124 acquires information of setting related to disposition of the virtual object determined in advance (hereinafter, referred to as disposition setting). The disposition setting acquisition unit 124 may acquire the disposition setting from the storage unit 17, for example, or from another device via the communication unit 15. The disposition setting acquisition unit 124 provides the acquired disposition setting to the display control unit 126.

The disposition setting may include information such as a shape, the number, an arrangement order, a size, and a disposition direction of the virtual object, whether the size thereof can be changed, whether the disposition direction thereof can be changed, and the like.

The display control unit 126 performs display control for the display unit 13, and disposes the virtual object in the field of vision of the user based on the disposition setting, for example. For example, in a case in which the conspicuous region is specified by the conspicuous region specification unit 122, the display control unit 126 may perform display control to dispose the virtual object in the conspicuous region.

In a case of disposing the virtual object in the conspicuous region, the display control unit 126 may change the size of the virtual object, or change the disposition direction of the virtual object depending on the conspicuous region. For example, the display control unit 126 may change the size of the virtual object to fall within the conspicuous region. Alternatively, the disposition direction of the virtual object may be changed in accordance with the shape of the conspicuous region, and the virtual object may be disposed in the disposition direction corresponding to the shape of the conspicuous region. For example, as described above, in a case in which the region along the edge is specified as the conspicuous region, the virtual object may be disposed along the edge.

The display control unit 126 may also dispose the virtual object in accordance with information of whether the size of the virtual object can be changed, or information of whether the disposition direction of the virtual object can be changed included in the disposition setting. For example, in a case in which the size of the virtual object cannot be changed, the display control unit 126 may dispose the virtual object not only in the conspicuous region but also on the outside of the conspicuous region without changing the size of the virtual object. In a case in which the disposition direction of the virtual object cannot be changed, the display control unit 126 may dispose the virtual object in the disposition direction that is set in advance based on the disposition setting without changing the disposition direction of the virtual object.

The display control unit 126 may also dispose the virtual object in a case in which the conspicuous region is not specified by the conspicuous region specification unit 122. For example, in a case in which the gazing point of the user is detected on a certain boundary surface but the conspicuous region is not specified because the edge is not detected in the vicinity of the gazing point, the display control unit 126 may dispose the virtual object in the vicinity of the gazing point. In another case in which the conspicuous region is not specified by the conspicuous region specification unit 122, the display control unit 126 may dispose the virtual object in front of the eyes of the user (for example, in the vicinity of the center of the field of vision). With this configuration, even in a case in which the conspicuous region is not specified, the user can easily find the virtual object.

Display Unit 13

For example, the display unit 13 is implemented by a lens unit that performs display using a hologram optical technique (an example of a transmissive-type display unit), a liquid crystal display (LCD) device, an Organic Light Emitting Diode (OLED) device, and the like. The display unit 13 may be a transmissive type, a transflective type, or a non-transmissive type.

Speaker 14

The speaker 14 reproduces a voice signal in accordance with control performed by the control unit 12.

Communication Unit 15

The communication unit 15 is a communication module for transmitting/receiving data to/from another device in a wired or wireless manner. The communication unit 15 performs wireless communication with an external apparatus directly or via a network access point using a scheme such as a wired Local Area Network (LAN), a wireless LAN, Wireless Fidelity (Wi-Fi) (registered trademark), infrared communication, Bluetooth (registered trademark), and short-range/non-contact communication, for example.

Operation Input Unit 16

The operation input unit 16 is implemented by an operation member having a physical structure such as a switch, a button, or a lever.

Storage Unit 17

The storage unit 17 stores computer programs and parameters for the control unit 12 described above to execute respective functions. For example, the storage unit 17 stores information (that may include the disposition setting) related to the virtual object.

The configuration of the information processing device 1 according to the embodiment has been specifically described above, but the configuration of the information processing device 1 according to the embodiment is not limited to the example illustrated in FIG. 2. For example, at least part of the functions of the control unit 12 of the information processing device 1 may be included in another device that is connected thereto via the communication unit 15.

### 3. Operation

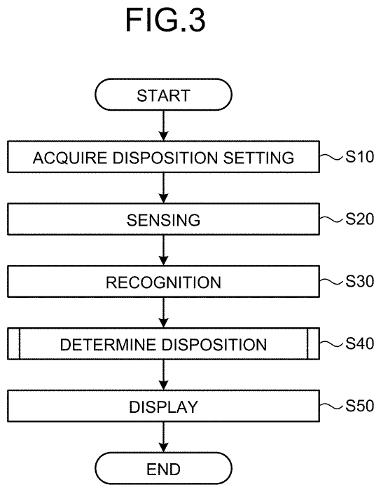

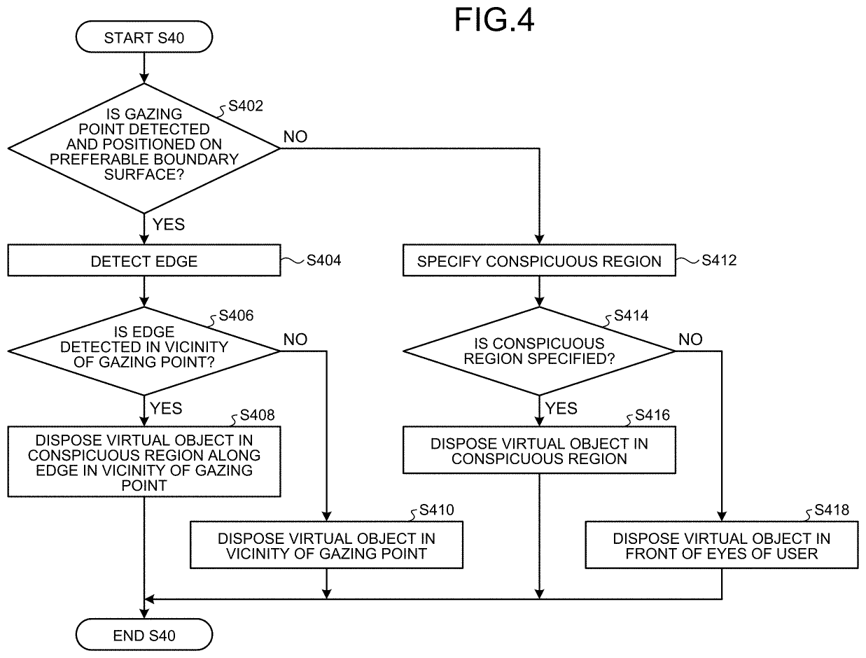

The configuration example of the information processing device 1 according to the embodiment has been described above. Subsequently, the following describes the operation of the information processing device 1 according to the embodiment with reference to FIG. 3 and FIG. 4. FIG. 3 is a flowchart illustrating an operation example of the information processing device 1 according to the embodiment.

As illustrated in FIG. 3, first, the disposition setting acquisition unit 124 acquires the disposition setting from the storage unit 17, or from another device via the communication unit 15 (S10).

Subsequently, sensing is performed by the sensor unit (S20), and the information about the user or the information about the peripheral situation is recognized by using various pieces of sensor information that are sensed (S30).

Subsequently, the conspicuous region specification unit 122 and the display control unit 126 determine disposition of the virtual object (S40). The following describes the processing at Step S40 in more detail with reference to FIG. 4. FIG. 4 is a flowchart illustrating the processing at Step S40 illustrated in FIG. 3 in more detail.

If the gazing point is detected and the gazing point is positioned on a preferable boundary surface (Yes at S402), the conspicuous region specification unit 122 performs edge detection on the boundary surface (S404). If an edge is detected in the vicinity of the gazing point (Yes at S406), the conspicuous region specification unit 122 specifies a region along the detected edge in the vicinity of the gazing point as the conspicuous region, and the display control unit 126 determines to dispose the virtual object in the conspicuous region (S408).

On the other hand, if the edge is not detected in the vicinity of the gazing point (No at S406), the display control unit 126 determines to dispose the virtual object in the vicinity of the gazing point (S410).

If the gazing point is not detected, or if the gazing point is not positioned on a preferable boundary surface (No at S402), the conspicuous region specification unit 122 specifies the conspicuous region by a method not using the gazing point (S412). At Step S412, the conspicuous region specification unit 122 may specify the conspicuous region based on the color information or the edge, for example.

If the conspicuous region is specified at Step S412 (Yes at S414), the display control unit 126 determines to dispose the virtual object in the conspicuous region (S416). On the other hand, if the conspicuous region is not specified at Step S412 (No at S414), the display control unit 126 determines to dispose the virtual object in front of the eyes of the user (for example, in the vicinity of the center of the field of vision) (S418).

Returning to FIG. 3, the description will be continued. As determined at Step S40, the display control unit 126 performs display control to dispose the virtual object, and causes the display unit 13 to display the virtual object (S50).

### 4. Specific Example in which Virtual Object is Disposed in Conspicuous Region

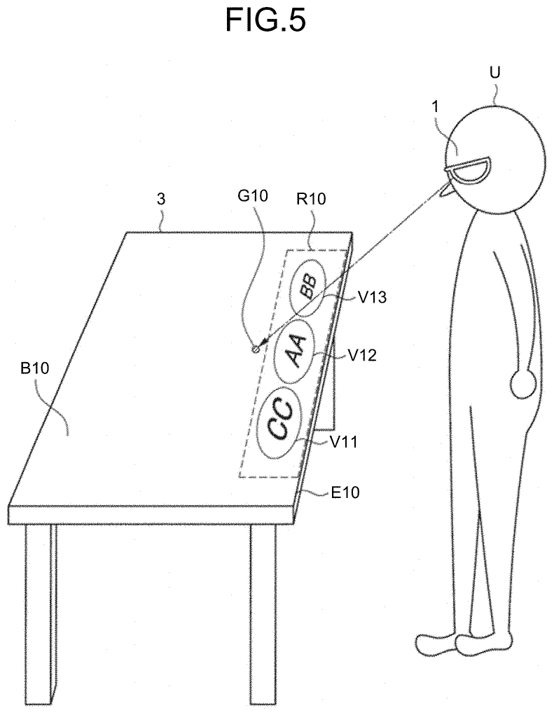

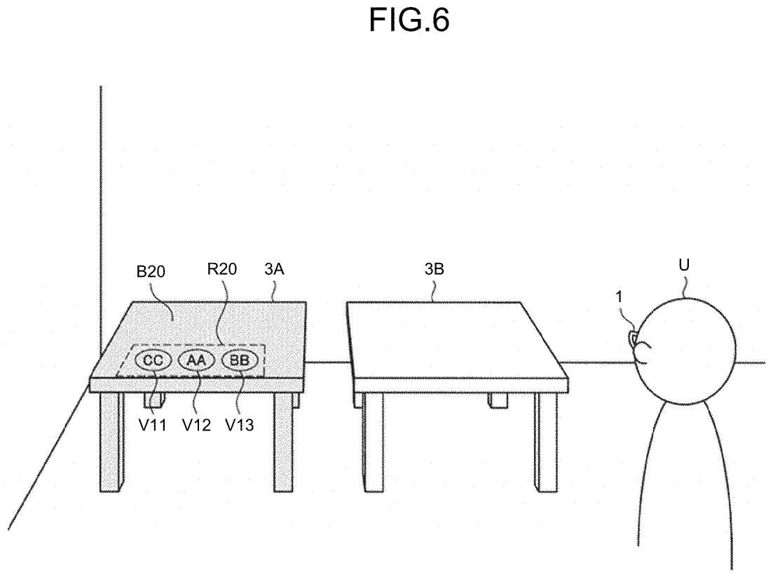

The operation of the information processing device 1 according to the embodiment has been described above. Subsequently, according to the embodiment, the following specifically describes an example of a case in which the virtual object is disposed in the conspicuous region with reference to FIG. 5 and FIG. 6. In FIG. 5 and FIG. 6, the user U wears the information processing device 1 that is a spectacle-type HMD as illustrated in FIG. 1. The display units 13 of the information processing device 1 positioned in front of the eyes of the user U are a transmissive type, and virtual objects V11 to V13 displayed on the display units 13 are visually recognized by the user U as if being present in the real space.

### 4-1. First Specific Example

FIG. 5 is an explanatory diagram for explaining an example in which the virtual object is disposed in the conspicuous region along the edge in the vicinity of the gazing point. In the example illustrated in FIG. 5, a gazing point G10 of the user U is positioned on a boundary surface B10 of a desk 3. A conspicuous region R10 along an edge E10 in the vicinity of the gazing point G10 is specified by the conspicuous region specification unit 122, and the virtual objects V11 to V13 are disposed in the conspicuous region R10.

The virtual objects V11 to V13 are disposed along the edge E10 present in the vicinity of the gazing point G10 of the user U, so that the user U can easily find the virtual objects V11 to V13, easily grasp a sense of distance thereto, and does not easily lose sight thereof.

### 4-2. Second Specific Example

FIG. 6 is an explanatory diagram for explaining another example in which the virtual object is disposed in the conspicuous region. In the example illustrated in FIG. 6, a desk 3A and a desk 3B are included in the field of vision of the user U. In a case in which the recognition unit 120 cannot detect the gazing point, or a case in which the detected gazing point is not positioned on a preferable boundary surface, the conspicuous region specification unit 122 specifies the conspicuous region without using the gazing point.

In the example illustrated in FIG. 6, as a result of specifying the conspicuous score for each boundary surface by the conspicuous region specification unit 122, a boundary surface B20 of the desk 3A has the highest conspicuous score, so that a conspicuous region R20 is specified on the boundary surface B20 by the conspicuous region specification unit 122. The virtual objects V11 to V13 are disposed in the conspicuous region R20.

On the boundary surface B20, the virtual objects V11 to V13 are disposed in the conspicuous region R20 that can easily attract visual attention of the user U, so that the user U can easily find the virtual objects V11 to V13 and can easily grasp a sense of distance thereto. In a case in which the conspicuous region R20 is specified based on the edge, the conspicuous region R20 is specified in the vicinity of the edge, and the user U does not easily lose sight of the virtual objects V11 to V13.

### 5. Modification

The embodiment of the present disclosure has been described above. The following describes some modifications of the embodiment. The modifications described below may be singly applied to the embodiment, or may be combined with each other to be applied to the embodiment. Each of the modifications may be applied in place of the configuration described in the embodiment, or may be additionally applied to the configuration described in the embodiment.

### 5-1. First Modification

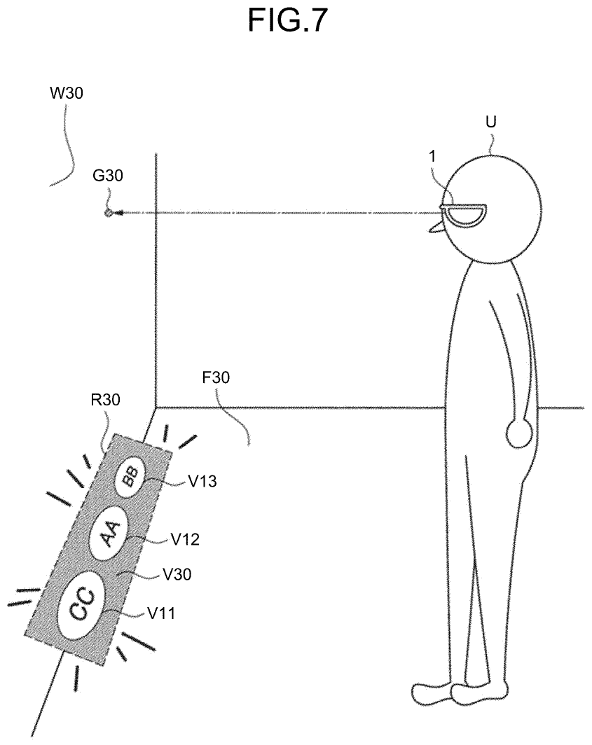

The virtual object that is caused to be displayed by the display control unit 126 is not limited to a still virtual object, and may include an animation. In such a case, the display control unit 126 may cause an animation to be displayed based on the conspicuous region. The following describes such an example with reference to FIG. 7 as a first modification. FIG. 7 is an explanatory diagram for explaining the present modification.

In the example illustrated in FIG. 7, a conspicuous region R30 along an edge between a wall W30 as a boundary surface and a floor F30 as a boundary surface is specified. The display control unit 126 disposes the virtual objects V11 to V13 in the conspicuous region R30. Additionally, the display control unit 126 causes an auxiliary virtual object V30 as a blinking animation to be displayed in the conspicuous region R30. With this configuration, the user is enabled to find the virtual objects V11 to V13 more easily.

Display of an animation based on the conspicuous region is not limited to the example described above. For example, the display control unit 126 may cause an animation having a starting position at a certain position in the conspicuous region to be displayed.

It can be considered to display, as the auxiliary virtual object for causing the user to find the virtual object, an animation starting from the starting position in the vicinity of the gazing point (for example, the gazing point G30 in the example of FIG. 7) toward a virtual object to be found. However, in a case in which a distance between the virtual object to be found and the gazing point is large, a large region of the field of vision of the user may be covered by the animation. On the other hand, in a case of displaying an animation having the starting position at a certain position in the conspicuous region, the user can be caused to find the virtual object even with a relatively small animation that does not cover the field of vision of the user.

### 5-2. Second Modification

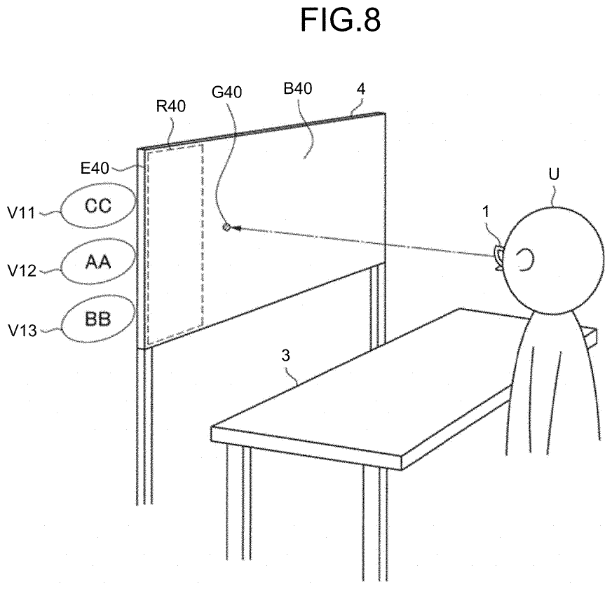

Described above is the example in which the virtual object is disposed in the conspicuous region that is specified on the boundary surface on which the gazing point is positioned, but the present technique is not limited thereto. For example, in a case in which a gazing time of the user is longer than a predetermined threshold, the display control unit 126 may dispose the virtual object at a position other than the boundary surface on which the gazing point is positioned. Such an example is described below with reference to FIG. 8 as a second modification. FIG. 8 is an explanatory diagram for explaining the present modification.

In the example illustrated in FIG. 8, a gazing point G40 of the user is positioned on a boundary surface B40 of a display 4. Thus, the conspicuous region specification unit 122 can specify a conspicuous region R40 along an edge E40 detected in the vicinity of the gazing point G40.

However, in a case in which the gazing time of the user is large, the user gazes at the display 4 with concentration, so that, if the virtual object is disposed in the conspicuous region R40 on the boundary surface B40 of the display 4, the virtual object may become an obstacle to the user. Thus, in a case in which the gazing time of the user is large, it may be effective that the display control unit 126 causes the virtual object to be displayed not in the conspicuous region R40 but at a place other than the boundary surface B40. For example, in a case in which the gazing time of the user is large, as illustrated in FIG. 8, the display control unit 126 disposes the virtual objects V11 to V13 along the edge E40 on the opposite side of the boundary surface B40. With this configuration, the virtual objects V11 to V13 can be disposed at positions that can be easily found and the sight thereof is not easily lost by the user while avoiding being obstacle to the user.

### 5-3. Third Modification

In the above description, described is the example in which the field of vision of the user is the real space and the virtual object is disposed on the display unit of a transmissive type, but the present technique is not limited thereto.

For example, also in a case in which the display unit 13 is a non-transmissive type, the same effect as that described above can be obtained by displaying the virtual object to be superimposed on an image of the real space obtained by photographing performed by the outward camera 110. Also in a case in which the display unit 13 is a projector, the same effect as that described above can be implemented by projecting the virtual object on the real space.

Alternatively, the field of vision of the user may be a virtual space, and the virtual space may be displayed on the display unit 13 of a non-transmissive type. In such a case, the display control unit 126 performs display control for the virtual space.

In such a case, a virtual object that has already been disposed in the virtual space may be used in place of the real object described above. For example, the conspicuous region may be specified on a boundary surface of the virtual object that has already been disposed, and a new virtual object may be disposed in the conspicuous region.

### 6. Hardware Configuration

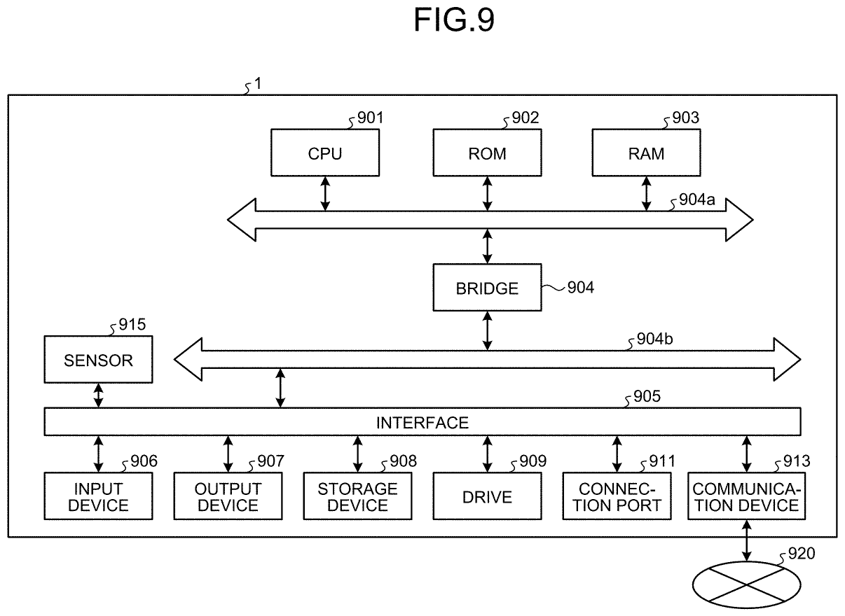

The embodiment of the present disclosure has been described above. Finally, the following describes a hardware configuration of the information processing device according to the embodiment with reference to FIG. 9. FIG. 9 is a block diagram illustrating an example of the hardware configuration of the information processing device 1 according to the embodiment. Information processing performed by the information processing device 1 according to the embodiment is implemented by software and hardware (described below) cooperating with each other.

As illustrated in FIG. 9, the information processing device 1 includes a Central Processing Unit (CPU) 901, a Read Only Memory (ROM) 902, a Random Access Memory (RAM) 903, and a host bus 904a. The information processing device 1 further includes a bridge 904, an external bus 904b, an interface 905, an input device 906, an output device 907, a storage device 908, a drive 909, a connection port 911, a communication device 913, and a sensor 915. The information processing device 1 may also include a processing circuit such as a DSP or an ASIC in place of or in addition to the CPU 901.

The CPU 901 functions as an arithmetic processing device and a control device, and controls the entire operation in the information processing device 1 in accordance with various computer programs. The CPU 901 may also be a microprocessor. The ROM 902 stores computer programs, arithmetic parameters, and the like used by the CPU 901. The RAM 903 temporarily stores computer programs used for executing the CPU 901, parameters that are appropriately changed due to the execution of the CPU 901, and the like. The CPU 901 may form, for example, the control unit 12.

The CPU 901, the ROM 902, and the RAM 903 are connected to each other via the host bus 904a including a CPU bus and the like. The host bus 904a is connected to the external bus 904b such as a Peripheral Component Interconnect/Interface (PCI) bus via the bridge 904. The host bus 904a, the bridge 904, and the external bus 904b are not necessarily configured in a separated manner, and these functions may be implemented as one bus.

The input device 906 is, for example, implemented by a device to which information is input by the user such as a mouse, a keyboard, a touch panel, a button, a microphone, a switch, and a lever. For example, the input device 906 may also be a remote control device utilizing infrared rays or other radio waves, or an external connection appliance such as a cellular telephone or a PDA supporting an operation of the information processing device 1. The input device 906 may further include, for example, an input control circuit that generates an input signal based on information that is input by the user using the input unit described above, and outputs the input signal to the CPU 901. The user of the information processing device 1 can input various kinds of data or give an instruction to perform processing operation to the information processing device 1 by operating the input device 906.

The output device 907 is formed of a device that can visually or aurally notify the user of acquired information. As such a device, exemplified are a display device such as a CRT display device, a liquid crystal display device, a plasma display device, an EL display device, and a lamp, a voice output device such as a speaker and a headphone, a printer device, and the like. For example, the output device 907 outputs a result obtained through various kinds of processing performed by the information processing device 1. Specifically, the display device visually displays the result obtained through various kinds of processing performed by the information processing device 1 in various formats such as text, an image, a table, and a graph. On the other hand, the voice output device converts an audio signal constituted of reproduced voice data, audio data, and the like into an analog signal to be aurally output. The output device 907 may form the display unit 13, for example.

The storage device 908 is a device for storing data that is formed as an example of a storage unit of the information processing device 1. The storage device 908 is implemented by, for example, a magnetic storage unit device such as an HDD, a semiconductor storage device, an optical storage device, or a magneto-optical storage device. The storage device 908 may include a storage medium, a recording device that records data in the storage medium, a reading device that reads out data from the storage medium, a deletion device that deletes data recorded in the storage medium, and the like. The storage device 908 stores a computer program executed by the CPU 901, various kinds of data, various kinds of data acquired from the outside, and the like. The storage device 908 described above may form the storage unit 17, for example.

The drive 909 is a reader/writer for a storage medium, and is incorporated in the information processing device 1, or externally attached thereto. The drive 909 reads out information recorded in a removable storage medium mounted thereon such as a magnetic disc, an optical disc, a magneto-optical disc, or a semiconductor memory, and outputs the information to the RAM 903. The drive 909 can also write the information into the removable storage medium.

The connection port 911 is an interface that is connected to an external apparatus, for example, a connection port for an external apparatus to which data can be transmitted via a Universal Serial Bus (USB) and the like.

The communication device 913 is, for example, a communication interface formed of a communication device and the like to be connected to the network 920. The communication device 913 is, for example, a communication card for a wired or wireless Local Area Network (LAN), Long Term Evolution (LTE), Bluetooth (registered trademark), or a Wireless USB (WUSB). The communication device 913 may also be a router for optical communication, a router for an Asymmetric Digital Subscriber Line (ADSL), a modem for various kinds of communication, or the like. The communication device 913 can transmit/receive a signal and the like to/from the Internet or another communication device according to a predetermined protocol such as TCP/IP, for example. The communication device 913 may form the communication unit 15, for example.

The sensor 915 is, for example, various sensors such as an acceleration sensor, a gyro sensor, a geomagnetic sensor, an optical sensor, a sound sensor, a range sensor, and a force sensor. The sensor 915 acquires information about a state of the information processing device 1 itself such as a posture and a moving speed of the information processing device 1, and information about a peripheral environment of the information processing device 1 such as brightness and noise around the information processing device 1. The sensor 915 may also include a GPS sensor that receives GPS signals to measure latitude, longitude, and altitude of a device. The sensor 915 may form, for example, the sensor unit 11.

The network 920 is a wired or wireless transmission path for information transmitted from a device connected to the network 920. For example, the network 920 may include a public network such as the Internet, a telephone line network, and a satellite communication network, various kinds of Local Area Network (LAN) including Ethernet (registered trademark), a Wide Area Network (WAN), and the like. The network 920 may also include a dedicated network such as an Internet Protocol-Virtual Private Network (IP-VPN).

The example of the hardware configuration that can implement the function of the information processing device 1 according to the embodiment has been described above. The constituent elements described above may be implemented by using a versatile member, or may be implemented as hardware dedicated to the function of each constituent element. Thus, a hardware configuration to be utilized can be appropriately changed depending on a technical level at each time of implementing the embodiment.

A computer program can be made for implementing each function of the information processing device 1 according to the embodiment as described above, and the computer program may be implemented on a PC and the like. A computer-readable recording medium storing such a computer program can also be provided. The recording medium is, for example, a magnetic disc, an optical disc, a magneto-optical disc, and a flash memory. The computer program described above may be distributed via a network, for example, without using a recording medium.

### 7. Conclusion

As described above, according to the embodiment of the present disclosure, the virtual object can be displayed at a position that can be easily found by the user.

The preferred embodiment of the present disclosure has been described above in detail with reference to the attached drawings, but the technical scope of the present disclosure is not limited to the example herein. A person ordinarily skilled in the art of the present disclosure can obviously conceive various examples of variations or modifications within a scope of technical idea described in CLAIMS, and it is obvious that these examples are also encompassed by the technical scope of the present disclosure.

For example, the steps in the embodiment described above are not necessarily processed on a time-series basis in accordance with the order described herein as the flowchart. For example, the steps in the processing of the embodiment described above may be processed in order different from the order described as the flowchart, or may be processed in parallel.

The effects described in the present description are merely explanation or examples, and are not limitations. That is, the technique according to the present disclosure can exhibit another effect that is obvious to those skilled in the art from the description herein in addition to the effect described above, or in place of the effect described above.

The following configurations are also encompassed by the technical scope of the present disclosure.

(1)

An information processing device comprising:

a conspicuous region specification unit configured to specify a conspicuous region that is able to relatively easily attract visual attention of a user in a field of vision of the user; and

a display control unit configured to perform display control to dispose a virtual object in the conspicuous region.

(2)

The information processing device according to (1), wherein the conspicuous region specification unit specifies the conspicuous region on a boundary surface detected from the field of vision.

(3)

The information processing device according to (2), wherein the conspicuous region specification unit specifies the conspicuous region based on an edge of the boundary surface detected from the field of vision.

(4)

The information processing device according to (3), wherein the conspicuous region specification unit specifies the conspicuous region further based on a gazing point of the user.

(5)

The information processing device according to (4), wherein the conspicuous region specification unit specifies the conspicuous region on the boundary surface on which the gazing point of the user is positioned.

(6)

The information processing device according to (5), wherein, in a case in which the edge is detected in the vicinity of the gazing point, the conspicuous region specification unit specifies a region along the detected edge as the conspicuous region.

(7)

The information processing device according to (6), wherein, in a case in which the edge is not detected in the vicinity of the gazing point of the user, the display control unit disposes the virtual object in the vicinity of the gazing point.

(8)

The information processing device according to any one of (4) to (7), wherein, in a case in which a gazing time of the user is longer than a predetermined threshold, the display control unit disposes the virtual object at a position other than the boundary surface on which the gazing point is positioned.

(9)

The information processing device according to any one of (2) to (8), wherein the conspicuous region specification unit specifies the conspicuous region based on color information in the field of vision.

(10)

The information processing device according to any one of (2) to (9), wherein the display control unit specifies a conspicuous score indicating ease of attracting visual attention of the user for each boundary surface, and specifies the conspicuous region on the boundary surface having the highest conspicuous score.

(11)

The information processing device according to any one of (1) to (10), wherein the display control unit disposes the virtual object in a disposition direction corresponding to a shape of the conspicuous region.

(12)

The information processing device according to any one of (1) to (11), wherein the display control unit causes an animation to be displayed based on the conspicuous region.

(13)

The information processing device according to any one of (1) to (12), wherein

the field of vision of the user is a real space, and

the display control unit performs the display control related to a display unit of a transmissive type.

(14)

The information processing device according to any one of (1) to (13), wherein

the field of vision of the user is a virtual space, and

the display control unit performs the display control related to a virtual space.

(15)

An information processing method comprising:

specifying a conspicuous region that is able to relatively easily attract visual attention of a user in a field of vision of the user; and

performing display control to dispose a virtual object in the conspicuous region by a processor.

(16)

A computer program that causes a computer to execute:

a function of specifying a conspicuous region that is able to relatively easily attract visual attention of a user in a field of vision of the user; and

a function of performing display control to dispose a virtual object in the conspicuous region.

### REFERENCE SIGNS LIST

1 INFORMATION PROCESSING DEVICE
11 SENSOR UNIT
12 CONTROL UNIT
13 DISPLAY UNIT
14 SPEAKER
15 COMMUNICATION UNIT
16 OPERATION INPUT UNIT
17 STORAGE UNIT
110 OUTWARD CAMERA
111 INWARD CAMERA
112 MIC
113 GYRO SENSOR
114 ACCELERATION SENSOR
115 AZIMUTH SENSOR
116 POSITION MEASURING UNIT
117 BIOSENSOR
120 RECOGNITION UNIT
122 CONSPICUOUS REGION SPECIFICATION UNIT
124 DISPOSITION SETTING ACQUISITION UNIT
126 DISPLAY CONTROL UNIT

1. An information processing device comprising:
a conspicuous region specification unit configured to specify a conspicuous region that is able to relatively easily attract visual attention of a user in a field of vision of the user; and
a display control unit configured to perform display control to dispose a virtual object in the conspicuous region.

2. The information processing device according to claim 1, wherein the conspicuous region specification unit specifies the conspicuous region on a boundary surface detected from the field of vision.

3. The information processing device according to claim 2, wherein the conspicuous region specification unit specifies the conspicuous region based on an edge of the boundary surface detected from the field of vision.

4. The information processing device according to claim 3, wherein the conspicuous region specification unit specifies the conspicuous region further based on a gazing point of the user.

5. The information processing device according to claim 4, wherein the conspicuous region specification unit specifies the conspicuous region on the boundary surface on which the gazing point of the user is positioned.

6. The information processing device according to claim 5, wherein, in a case in which the edge is detected in the vicinity of the gazing point, the conspicuous region specification unit specifies a region along the detected edge as the conspicuous region.

7. The information processing device according to claim 6, wherein, in a case in which the edge is not detected in the vicinity of the gazing point of the user, the display control unit disposes the virtual object in the vicinity of the gazing point.

8. The information processing device according to claim 4, wherein, in a case in which a gazing time of the user is longer than a predetermined threshold, the display control unit disposes the virtual object at a position other than the boundary surface on which the gazing point is positioned.

9. The information processing device according to claim 2, wherein the conspicuous region specification unit specifies the conspicuous region based on color information in the field of vision.

10. The information processing device according to claim 2, wherein the display control unit specifies a conspicuous score indicating ease of attracting visual attention of the user for each boundary surface, and specifies the conspicuous region on the boundary surface having the highest conspicuous score.

11. The information processing device according to claim 1, wherein the display control unit disposes the virtual object in a disposition direction corresponding to a shape of the conspicuous region.

12. The information processing device according to claim 1, wherein the display control unit causes an animation to be displayed based on the conspicuous region.

13. The information processing device according to claim 1, wherein
the field of vision of the user is a real space, and
the display control unit performs the display control related to a display unit of a transmissive type.

14. The information processing device according to claim 1, wherein
the field of vision of the user is a virtual space, and
the display control unit performs the display control related to a virtual space.

15. An information processing method comprising:
specifying a conspicuous region that is able to relatively easily attract visual attention of a user in a field of vision of the user; and
performing display control to dispose a virtual object in the conspicuous region by a processor.

16. A computer program that causes a computer to execute:
a function of specifying a conspicuous region that is able to relatively easily attract visual attention of a user in a field of vision of the user; and
a function of performing display control to dispose a virtual object in the conspicuous region.
